(19) United States
(12) Patent Application Publication
(10) Pub. No.: US 2009/0094896 A1
(43) Pub. Date: Apr. 16, 2009

(54) Apparatus for wind protection of building openings

(76) Inventors: Leonard Charles Quick, Mandeville, LA (US); Gaetano Dominick Paternostro, JR., Big Branch, LA (US)

Correspondence Address: KENNETH L. TOLAR, 2908 Hessmer Avenue, Metairie, LA, 70002, US

(21) Appl. No.: 11/973,803

(22) Filed: Oct. 10, 2007

Related U.S. Application Data
(63) Continuation-in-part of application No. 11/077,447, filed on Mar. 10, 2005.

(51) Int. Cl. E06B 3/68

(52) U.S. Cl. 49/55

(57) ABSTRACT

A retaining bar for securing position of a protective panel within a recess of a building, such as a window frame or a door frame. The retaining bar has two telescopically engageable portions, which are tensioned in the frame. Each retaining bar member carries a resilient pad, which contacts the window or door frame once the bar members are extended to fit tightly within the flame. A threaded rod of one of the mounting assemblies allows tightening of the retaining bar in the frame.

### CROSS-REFERENCE TO RELATED APPLICATIONS

This application is a continuation-in-part of my co-pending application Ser. No. 11/077,447 filed on Mar. 10, 2005, entitled “Apparatus for Wind Protection of Building Openings,” the full disclosure of which is incorporated by reference herein and priority of which is hereby claimed.

### BACKGROUND OF THE INVENTION

The present invention relates to the protection of windows and doors from strong winds, such as occasioned by hurricane and other natural forces. More particularly, the present invention relates to a device for securing protective panels in window and door frames to help protect glass from flying objects and from wind forces during storms, hurricanes, tornadoes and the like.

Many buildings in certain areas of the country are damaged by violent storms when wind-carried objects are hurled against glass covered windows and doors. The objects flown by wind can cause substantial damage to the structure. It is common in preparation for hurricanes to place plywood or wooden panels on the outside of the structure to help protect the buildings and prevent glass breakage. Conventionally, the protective panels are installed by either screws or nails driven through the panels directly into the window frames. However, driving screws and nails into the aluminum frame window is difficult, often makes unsightly holes in the structure and can cause breakage of the glass due to vibration. Additionally, many manufacturers, while providing warranty to the windows and frames, will not honor the warranty if a screw hole or nail hole is made in the window frame. The created holes create an opportunity for moisture to penetrate into the building or inside the wood structure, which will gradually damage the window frame and may require expensive replacement.

The present invention contemplates elimination of drawbacks associated with conventional methods of installing protective coverings for a building opening and provision of a device for retaining protective panels in place without the need for penetrating the frame of a window, door, or veneer covering of the building.

### SUMMARY OF THE INVENTION

It is therefore, an object of the present invention to provide an apparatus for retaining a wind protection panel in a frame opening of a door or window of a building.

It is another object of the present invention to provide an apparatus for retaining a protective panel in the building opening structure without using complicated equipment or skilled labor.

it is a further object of the present invention to provide an apparatus for retaining a protective panel in the building opening structure where the end tensioning members are formed resilient to prevent slipping of the tensioned bar members within the frame of the structure openings.

These and other objects of the present invention are achieved through a provision of an apparatus for retaining protecting panels placed in a recess of a wall of a building, more specifically within a window frame or a door frame. The apparatus comprises at least one retainer bar, which is tensioned in the frame outside of a protective panel, be it a plywood, panel, plastic panel or metal panel. The retaining bar is formed as a two-part elongated member, where a first portion, or bar member, telescopically receives a second portion, or second bar member.

The first bar member is provided with a row of through openings, through which a locking button extends to lock the longitudinal extension of the second bar member from the first bar member. The locking button, or buttons are secured to a tensioned member, which is positioned inside the second bar member, urging the button outwardly, through the locking opening.

Each bar member carries a mounting assembly on a free end thereof. The first mounting assembly has a resilient pad for contacting the frame without damaging the frame, and an end cap securable with the free end of the first bar member. A deflection means prevents over-tightening of the retainer bar in the frame. The deflection means can be in the form of Belleville washers fitted or stacked between the resilient pad and the cap. The second mounting assembly mounted on a free end of the second bar member also has a resilient pad for contacting the frame and an internally threaded cap for engaging the bar member. A threaded bolt carried by the cap of the second mounting assembly engages with the threaded opening of the second cap. A locking member, such as a locking wing nut is mounted between the second cap and the second. pad to allow selective adjustable tightening of the retaining bar within the building frame. Rotating the first bar member in relation to the second bar member allows tightening of position of the retaining member within the frame.

### BRIEF DESCRIPTION OF THE DRAWINGS

Reference will now be made to the drawings, wherein like parts are designated by like numerals and wherein

FIG. 1 is a perspective view of the apparatus of the present invention installed in a window frame.

FIG. 2 is a detail view illustrating position of the bracket assembly when installed in a building opening frame.

FIG. 3 is a detail, partially cutaway view, illustrating a fixed end bracket assembly of the apparatus of the present invention.

FIG. 4 is a detail, partially cutaway view, illustrating a means for adjusting the length of the retaining bar of the apparatus of the present invention.

FIG. 5 is a detail, partially cutaway view, illustrating a threaded end of the retainer bar of the present invention.

FIG. 6 is an exploded view of the apparatus of the present invention.

FIG. 7 is a detail view of the washer assembly at the swivel end of the assembly.

FIG. 8 is a detail view of the swivel cap with an engaged shaft.

FIG. 9 is a detail view of the resilient cap with an engaged threaded rod.

FIG. 10 is a detail view of the first end cap.

FIG. 11 is a detail view of the second end cap.

### DETAILED DESCRIPTION OF THE PREFERRED EMBODIMENT

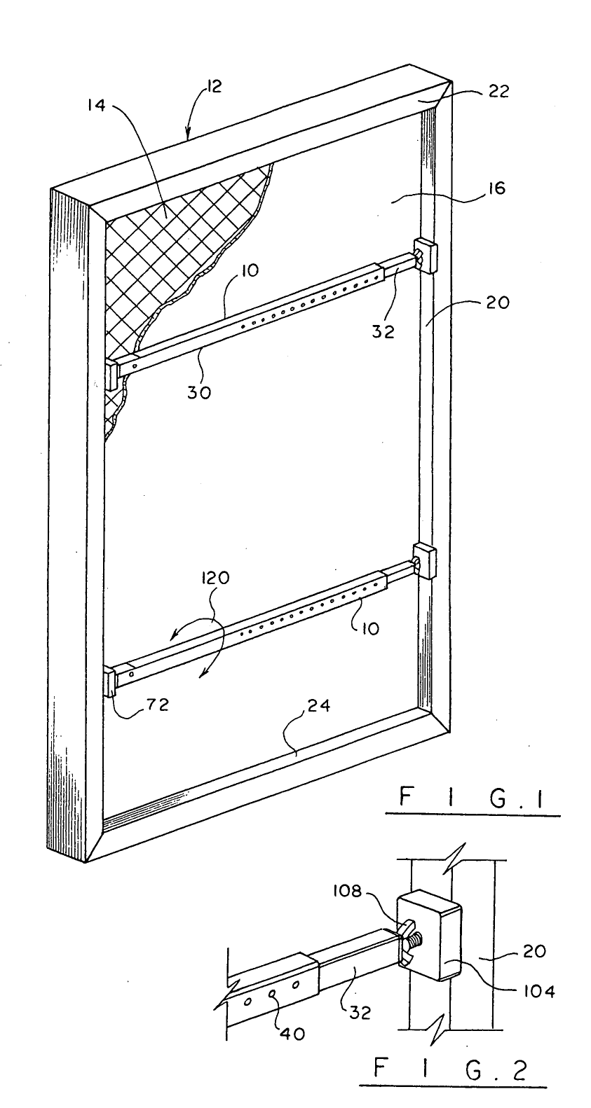

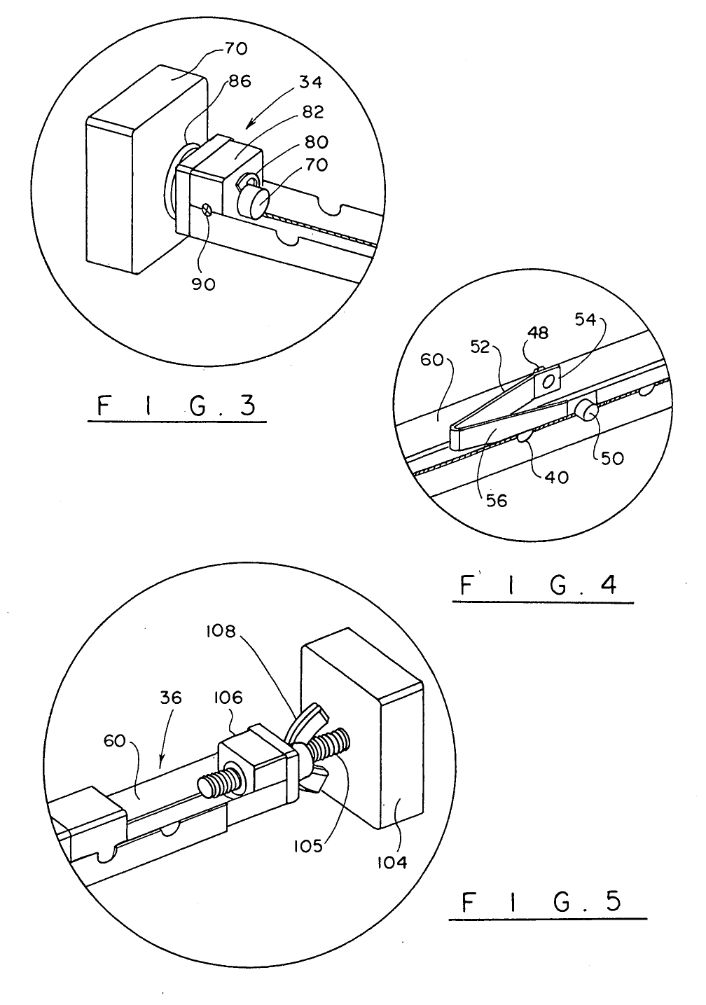

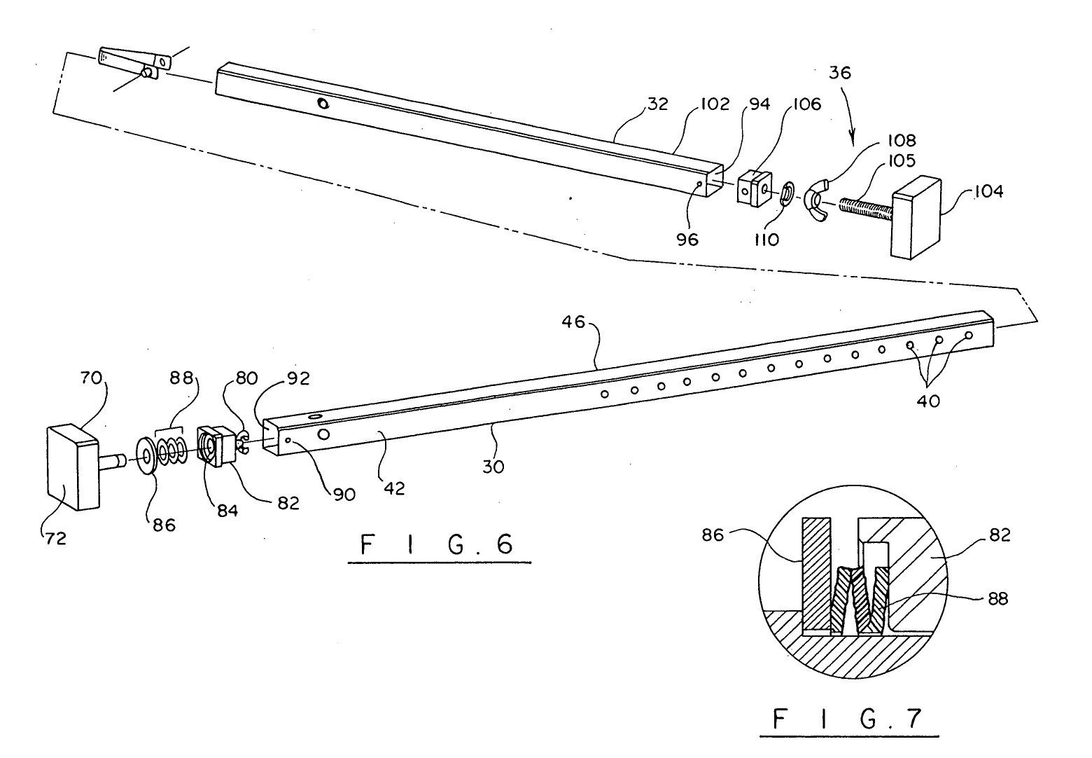

Turning now to the drawings in more detail, numeral 10 designates a retaining bar in accordance with the present invention. As can be seen in FIG. 1, one or more retaining bars 10 may be provided for each building opening, depending on the height of the opening and the size of the protective panel. A window frame or a door frame 12 is provided with a fragile panel 14, for instance a glass panel. In preparation for storm, the user cuts out a protective panel 16 which can be made of plywood, metal, plastic, or other structurally sound protective material. The panel 16 is sized to fit within the opening defined by the frame 12 and tightly fit against vertical frame members 18, 20, as well as horizontal frame members 22 and 24.

The retaining bars 10 are positioned within the frame, tensioned between the vertical panel members 18 and 20, or may be tensioned between horizontal frame members 22, 24, if desired. Each of the retaining bars 10 is comprised of two elongated members, a first elongated tubular bar member 30 and a second elongated bar member 32 telescopically engageable within a tubular opening of the first bar member 30.

A first mounting assembly 34 is secured on a free end of the first bar member 30. A second mounting assembly 36 is secured on the free end of the second bar member 32. The first bar member 30 is provided with a plurality of openings 40 formed through an outside wall 42 of the first bar member 30. Corresponding openings are formed in the inside wall 46 of the first bar member 30. The openings 40 and the openings on the inside wall are aligned, allowing extension of a locking means therethrough.

The locking means of the present invention comprises one or more snap buttons 48 and 50, which are extendable through the openings 40 and the opposing openings when released. The snap buttons 48 and 50 are secured on a tension member 52, which has a generally V-shaped configuration and carries the snap buttons 48 and 50 on respective legs 54 and 56. The tension member 52 normally urges the locking buttons 48, 50 into the openings in the inside wall and the outside wall 42, 46. When depressed, the snap buttons 48 and 50 recede into a channel 60 defined by the second bar member 32 (FIG. 4), facilitating telescopical slidable movement of the second bar member 32 in relation to the first bar member 30. When released, the snap buttons 48 and 50 are forced into the aligned openings in the walls 42, 46, thereby fixing the length of the retainer bar 10 to the desired length for the opening in the frame 12.

The first mounting assembly 34 comprises a contact pad 70 that has a distant surface 72 and a proximate surface 74. The distant surface 72 is adapted for contacting the frame member 22. The contact pad is formed from a resilient material that can be compressed to a degree to ensure a firm contact with the frame 12. Fitted in the contact pad 70 is a shaft 76 that carries a transverse plate 77 on an inner end thereof. When engaged with the pad 70, the transverse plate 77 prevents disengagement of the shaft 76 from the pad 72. The shaft 76 extends outwardly from the surface 74. The shaft 76 is provided with a peripheral groove 78 for receiving a split snap ring 80 therein.

The first mounting assembly further comprises a first end cap 82 which has a through opening 83 and a counter bore 84 that has a larger diameter than the central opening. A flat ring-shaped washer 86 engages the shaft 76 and contacts the first pad 70. A plurality of Belleville washers 88 are engaged on the shaft 76 between the flat washer 86 and the first end cap 82 to act as deflection means between the end cap 82 and the pad 70. The stacked together Belleville washers provide a spring action when the first bar member 30 is rotated to tighten the protector assembly in the frame 12. The amount of the Belleville washers may differ to modify the spring constant or amount of deflection provided by the mounting assembly 34. Stacking in the same direction will add the spring constant in parallel, creating a stiffer joint (with the same deflection). Stacking in an alternating direction will result in a lower spring constant and greater deflection. Mixing and matching directions will allow a specific spring constant and deflection capacity to be designed.

A securing pin (not shown) can be inserted through openings 90, 92 formed in the first retaining bar member 30. Another securing pin (not shown) may be inserted through aligned openings 94, 96 of the second retaining bar member 32. The first end cap is sized and configured to at least partially fit within the channel defined by the first retaining bar member 30.

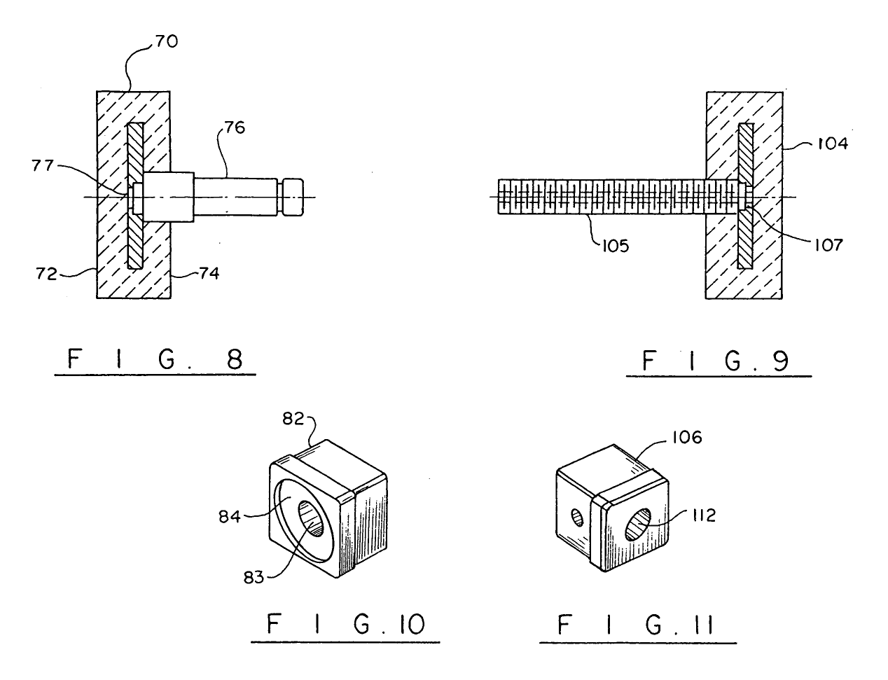

The second mounting assembly 36 is provided for engaging an end 102 of the second bar member 32. The second mounting assembly 36 comprises a second contact pad 104 which carries a threaded bolt 105, a second end cap 106, and a tightening member 108. A lock washer 110 is fitted between the second end cap 106 and the tightening member 108. The tightening member 108 may be a wing nut, as shown in the drawings, or any other type of a tightening device. As can be seen in FIG. 9, the threaded bolt 105 carries a transverse plate 107 which is engaged in the pad 104 and prevents disengagement of the bolt 105 from the contact pad 104.

The second end cap 106 is provided with a threaded opening 112 which is adapted for engaging the threaded bolt 105. The end cap 106 is sized and configured to at least partially fit within the channel 60 defined by the second bar member 32.

The contact pads 70 and 104 can be made from a material that hardens when cooled, such as for instance neoprene. This material provides a certain degree of resilience while not being damaging to the frame 12. The transverse plates 77 and 107 and portions of the shaft 76 and threaded bolt 105 may become encased within the pads 70, 104 and prevent disengagement therefrom.

In operation, the user places the protective panel 16 over the glass 14 and mounts one or two retainer bars 10 within the vertical frame members 18 and 20. First, a fixed end with the first mounting assembly 34 is placed against the inside of the frame member 18. The pad 70 presses against the frame 18, as shown in FIG. 1. The second bar member 32 is extended outwardly from the first bar member 30 until the second pad 104 contacts the inside of the vertical frame member 20, as shown in FIG. 2. The rod 105 allows rotation of the assembly so that a tight fit is achieved.

Next, the adjustable snap buttons 48 and 50 are depressed to allow movement of the bar 32 in relation to the bar member 30 for a rough adjustment. The retainer bar member 30 is rotated, with the snap buttons 48 and 50 depressed to achieve the desired tight fit. The mounting assemblies 34 and 36 do not rotate at this time. The tightening rod 102 may be inserted into the openings 90, 92 to further ensure a tight position of the bar 10 within the frame 12. The washer 110 prevents over tightening of the retainer bar 10.

Once the desired position is achieved, the snap buttons 48 and 50 can be released to snap into position and to further ensure a secure grip of the retaining bar against the interior of the frame members 18 and 20. If desired, the first bar member 30 can be rotated in relation to the panel in the directions of arrow 120 (FIG. 1) to tighten or loosen position of the retaining bar 10 in the frame. If necessary, an open-end wrench or a crescent wrench can be used to apply rotating force to the retaining bar member 30. Depending on the direction of rotation, the second bar member 32, moving along the threaded screw 105 can be extended or moved inside the first retaining bar member 30. The length of the bar members 30 and 32 is selected to be adjustable between a 3 foot window frame to a 4½ foot window frame or within larger windows or door openings. Once the proper tight fitting of the bar 10 within the frame 12 is achieved the wing nut 108 can e also rotated to further ensure a tight fitting.

The retainer bar 10 can be installed in a relatively short period of time following notification from the National Weather Service that a hurricane or tornado or other high windstorm is approaching. The protective panel 16 can be precut to fit into the desired openings and one or two retaining bars 10 positioned over the panel 16 to keep the panel 16 in place without using screws or nails. Once the danger has passed, the retainer bars 10 can be removed by loosening the position of the retainer bar member 30 and 32 in relation to each other, and the protective panel 16 removed and stored for future use if necessary.

The retainer bar 10 allows securing of the protective panel 16 within the building openings without any damage to the integral structure of the frames 12, thereby facilitating warranty protection offered by the manufacturer. The retaining bars 10 can be made from lightweight non-corrosive structurally strong material, such aluminum and the like.

Many changes and modifications can be made in the design of the present invention without departing from the spirit thereof. We therefore pray that our rights to the present invention be limited only by the scope of the appended claims.

I claim:

1. An apparatus for retaining protecting panels placed in a recess of a wall of a building fitted with a frame, comprising:
at least one adjustable retainer bar positioned between opposing frame members, said retainer bar comprising a first bar member provided with an interior channel, a second bar member telescopically slidably engaged within the channel of the first bar member, and a mounting assembly carried by a free end of each of said first bar member and the second bar member, each of said mounting assemblies being configured for tensioning against a respective frame member.

2. The apparatus of claim 1, wherein said first bar member is configured for free rotation in relation to the second bar member.

3. The apparatus of claim 1, further comprising a means for adjusting extension of the second bar member from the open end of the first bar member.

4. The apparatus of claim 3, wherein said extension adjusting means comprises a locking member mounted inside the second bar member, said locking member comprising at least one depressible locking button secured to a compressible tension member, said depressible locking button being configured, when released, to extend through one of a plurality of locking button receiving openings formed in the first bar member.

5. The apparatus of claim 1, wherein a first mounting assembly is adjustably mounted on a free end of the first bar member, said first mounting assembly comprising a first resilient pad for contacting a frame member, a first end cap engageable between the free end of the first bar member and the first resilient pad, and deflection means positioned between the first end cap and the first resilient pad.

6. The apparatus of claim 5, wherein said first resilient pad carries an elongated shaft extending outwardly from the first resilient pad, and wherein said first end cap and said deflection means are mounted on said shaft.

7. The apparatus of claim 5, wherein said deflection means comprises a plurality of Belleville washers stacked between the first end cap and the first pad.

8. The apparatus of claim 6, wherein said elongated shaft is provided with a circumferential groove at a free end thereof, and wherein a split snap ring is mounted in said groove to facilitate engagement of the first end cap with the first pad.

9. The apparatus of claim 1, wherein a second mounting assembly is mounted on a free end of the second bar member, said second mounting assembly allowing a limited adjustable movement of the second bar member in relation to the frame member so as to tighten the first bar member and the second bar member between opposing frame members.

10. The apparatus of claim 9, wherein the second mounting assembly comprises a second resilient pad, a second end cap adapted for engagement with a free end of the second bar member and a selective tightening means mounted between the second end cap and the second pad.

11. The apparatus of claim 10, wherein said tightening means comprises a threaded bolt secured to said second pad and extending through said second end cap, and a tightening member carried by said threaded bolt and mounted between the second end cap and the second pad.

12. An apparatus for retaining protecting panels placed in a recess of a wall of a building fitted with a frame, comprising:
at least one adjustable retainer bar positioned between opposing frame members, said retainer bar comprising a first bar member provided with an interior channel, a second bar member telescopically slidably engaged within the channel of the first bar member, a first mounting assembly carried by a free end of the first bar member, a second mounting assembly carried by a free end of the second bar member, said second mounting assembly being provided with a means for tightening position of the retainer bar between opposing frame members, and wherein the first mounting assembly is provided with a means for preventing over-tightening of position of said retainer bar in said frame.

13. The apparatus of claim 12, wherein said first mounting assembly comprises a first resilient pad for contacting a frame member, a first end cap engageable between the free end of the first bar member and the first resilient pad, and the means for preventing over-tightening positioned between the first end cap and the first resilient pad.

14. The apparatus of claim 13, wherein said means to prevent over-tightening comprises a plurality of Belleville washers stacked between the first end cap and the first pad.

15. The apparatus of claim 12, wherein said second mounting assembly allows a limited adjustable movement of the second bar member in relation to the frame member so as to tighten the first bar member and the second bar member between opposing frame members.

16. The apparatus of claim 12, wherein the second mounting assembly comprises a second resilient pad, a second end cap adapted for engagement with a free end of the second bar member and a selective tightening means mounted between the second end cap and the second pad.

17. The apparatus of claim 16, wherein said tightening means comprises a threaded bolt secured to said second pad and extending through said second end cap, and a tightening member carried by said threaded bolt and mounted between the second end cap and the second pad
